(19) United States
(12) Patent Application Publication
(10) Pub. No.: US 2018/0005148 A1
(43) Pub. Date: Jan. 4, 2018

(54) MAPPING RULE UPDATING METHOD, DEVICE AND SYSTEM

(71) Applicant: Siemens Aktiengesellschaft, Muenchen (DE)

(72) Inventors: Dan YU, Orinda, CA (US); Liang ZHANG, Beijing (CN)

(73) Assignee: Siemens Aktiengesellschaft, Muenchen (DE)

(21) Appl. No.: 15/636,839

(22) Filed: Jun. 29, 2017

(30) Foreign Application Priority Data
Jul. 1, 2016 (CN) 201610515032.4

(51) Int. Cl. G06Q 10/06; G06N 99/00; G06Q 10/10; G06F 9/445

(52) U.S. Cl. CPC G06Q 10/0631; G06Q 10/103; G06N 99/005; G06F 8/65

(57) ABSTRACT

Provided are a mapping rule updating method, device and system, for timely updating a mapping rule so as to avoid generating a wrong evaluation result. A mapping rule updating method, includes receiving first data generated in a production process; determining a first execution condition of the production process according to the first data based on a mapping rule; generating an evaluation result, the evaluation result being used for indicating whether the first execution condition is in line with a production plan of the production process; acquiring feedback information, the feedback information including indication information for indicating whether the evaluation result is correct; and updating the mapping rule according to the feedback information. As the mapping rule can be automatically updated, the work load of manually configuring the mapping rule is reduced greatly, and the accuracy of the mapping rule and the timeliness of the update is improved.

### PRIORITY STATEMENT

The present application hereby claims priority under 35 U.S.C. §119 to Chinese patent application number CN 201610515032.4 filed Jul. 1, 2016, the entire contents of which are hereby incorporated herein by reference.

### FIELD

At least one embodiment of the present invention generally relates to the technical field of production management, and to a mapping rule updating method, device and/or system.

### BACKGROUND

In the process of production management, a production process needs to be closely monitored, such that an error present in and a problem occurring in the production process can be found as early as possible. At present, one production process generally comprises hundreds or thousands of sub-processes, which makes production management more and more complicated.

The technique of digitalization realizes automated production management. After the digitizing technique is used, the following method can be adopted to monitor the production process. Field data generated in a production process is collected by a data collection device, the collected field data is converted into production data described in a production plan according to a pre-determined mapping rule, and an execution condition of the production process is learnt according to the converted production data (such as: determining whether an event in the production process has occurred). In addition, whether the execution condition mentioned above is in line with a production plan can further be determined according to a pre-determined production plan, so as to evaluate the production process.

Taking a production process in a factory as an example, conditions such as a material change, a plant layout change, a work flow adjustment may often happen, and these conditions may possibly result in a change to a mapping rule. If the old mapping rule is not updated, the wrong evaluation result may be generated.

### SUMMARY

At least one embodiment of the present invention provides a mapping rule updating method, device and system for timely updating a mapping rule so as to avoid generating the wrong evaluation result.

A first embodiment of the present invention provides a mapping rule updating method, comprising:

receiving first data generated in a production process;

determining a first execution condition of the production process according to the first data based on a mapping rule;

generating an evaluation result; the evaluation result being used for indicating whether the first execution condition is in line with a production plan of the production process;

acquiring feedback information, the feedback information comprising indication information for indicating whether the evaluation result is correct; and updating the mapping rule according to the feedback information.

A second embodiment of the present invention provides a mapping rule updating device, the device comprising:

a mapping unit for receiving first data generated in a production process; and determining a first execution condition of the production process according to the first data based on a mapping rule;

a production process evaluation model unit for generating an evaluation result; the evaluation result being used for indicating whether the first execution condition is in line with a production plan of the production process;

a self-learning unit for acquiring feedback information, and updating the mapping rule according to the feedback information; the feedback information comprising indication information for indicating whether the evaluation result is correct.

A third embodiment of the present invention provides a mapping rule updating device, the device comprising:

a memory storing program computer-readable instructions; and

one or more processors configured to execute the instructions such that the one or more processors are configured to,
receive first data generated in a production process and determine a first execution condition of the production process according to the first data based on a mapping rule;
generate an evaluation result; the evaluation result being used for indicating whether the first execution condition is in line with a production plan of the production process; and
acquire feedback information, and update the mapping rule according to the feedback information; the feedback information comprising indication information for indicating whether the evaluation result is correct.

A fourth embodiment of the present invention provides a mapping rule updating device, comprising:

a memory for storing a mapping rule;

a receiver for receiving first data generated in a production process; and

a processor for:
determining a first execution condition of the production process according to the first data based on a mapping rule;
generating an evaluation result; the evaluation result being used for indicating whether the first execution condition is in line with a production plan of the production process;
acquiring feedback information, the feedback information comprising indication information for indicating whether the evaluation result is correct; and
updating the mapping rule according to the feedback information.

A fifth embodiment of the present invention provides a production process management system, comprising:

at least one data collection device for collecting first data generated in a production process, and sending the first data to a mapping rule updating device; and

the mapping rule updating device for:
receiving the first data;
determining a first execution condition of the production process according to the first data based on a mapping rule;
generating an evaluation result; the evaluation result being used for indicating whether the first execution condition is in line with a production plan of the production process;
acquiring feedback information, the feedback information comprising indication information for indicating whether the evaluation result is correct; and
updating the mapping rule according to the feedback information.

A sixth embodiment of the present invention provides a computer readable medium, wherein the computer readable medium stores computer instructions thereon, which when executed by a processor, cause the processor to perform the method provided in the first embodiment or any possible implementation method of the first embodiment.

An embodiment of the present invention further provides a computer storage medium, storing an instruction for causing a machine to execute the checking method of program codes as described herein. Specifically, a system or apparatus with a storage medium may be provided, and software program codes for implementing the functions of any one of the embodiments described above are stored on the storage medium, and a computer (or CPU or MPU) of the system or apparatus is caused to read and execute the program codes stored in the storage medium.

In this condition, the program codes per se read from the storage medium may implement the functions of any one of the embodiments described above, and therefore the program codes and the storage medium storing the program codes constitute a part of an embodiment of the present invention.

### BRIEF DESCRIPTION OF THE DRAWINGS

FIG. 1 is a schematic structural diagram of a production process management system provided in an embodiment of the present invention;

FIG. 2 is a schematic structural diagram of another production process management system provided in an embodiment of the present invention;

FIG. 3 is a schematic structural diagram of still another production process management system provided in an embodiment of the present invention;

FIGS. 4-7 show four scenarios where the embodiments of the present invention apply;

FIG. 8 is a schematic structural diagram of a production process evaluation device provided in an embodiment of the present invention;

FIG. 9 is a schematic structural diagram of another production process evaluation device provided in an embodiment of the present invention; and

FIG. 10 is a flow chart of a production process evaluation method provided in an embodiment of the present invention.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (procesor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

A first embodiment of the present invention provides a mapping rule updating method, comprising:

receiving first data generated in a production process;

determining a first execution condition of the production process according to the first data based on a mapping rule;

generating an evaluation result; the evaluation result being used for indicating whether the first execution condition is in line with a production plan of the production process;

acquiring feedback information, the feedback information comprising indication information for indicating whether the evaluation result is correct; and

updating the mapping rule according to the feedback information.

As the mapping rule can be automatically updated, the work load of manually configuring the mapping rule is reduced greatly, and the accuracy of the mapping rule and the timeliness of the update is improved. By acquiring feedback information, the mapping rule can be updated in real time, so that an accurate evaluation result of the production process can be provided.

Optionally, after generating the evaluation result and before acquiring the feedback information, the method of at least one embodiment further comprises: sending evaluation result information for describing the evaluation result to an evaluation feedback device, the evaluation result information being used for the evaluation feedback device to display the evaluation result to an operator; and acquiring the feedback information comprises: receiving the feedback information from the evaluation feedback device, the feedback information being input on the evaluation feedback device by the operator according to the evaluation result.

By using the optional implementation method, the mapping rule can be modified according to the evaluation result input on the feedback device by the operator, so that a feedback opinion of the operator is collected in real time, and the mapping rule is timely updated.

Alternatively, optionally, after generating the evaluation result and before acquiring the feedback information, the method of at least one embodiment further comprises: sending evaluation result information for describing the evaluation result to an evaluation feedback device; and acquiring the feedback information comprises: receiving the feedback information from the evaluation feedback device, the feedback information being obtained by the evaluation feedback device according to the evaluation result.

By using the optional implementation method, the mapping rule can be modified according to the feedback information generated by the feedback device per se.

Further alternatively, optionally, after generating the evaluation result and before acquiring the feedback information, the method of at least one embodiment further comprises: receiving second data generated subsequently in the production process; and determining a second execution condition of the production process according to the second data based on the mapping rule; and acquiring the feedback information comprises: determining the feedback information according to a time sequence relationship described in the production plan, the time sequence relationship being a relationship between the second execution condition and the first execution condition.

By using the optional implementation method of at least one embodiment, the mapping rule is updated according to the subsequent execution condition of the production process, so that the purpose of accurately updating the mapping rule and obtaining a precise evaluation result is achieved.

Optionally, if the indication information indicates that the evaluation result is wrong, the feedback information further comprises: parameter modification information for modifying at least one parameter that describes the mapping rule.

By using the optional implementation method of at least one embodiment, a mapping rule parameter is modified, so that the modification for the mapping rule is more precise.

A second embodiment of the present invention provides a mapping rule updating device, the device comprising:

a mapping unit for receiving first data generated in a production process; and determining a first execution condition of the production process according to the first data based on a mapping rule;

a production process evaluation model unit for generating an evaluation result; the evaluation result being used for indicating whether the first execution condition is in line with a production plan of the production process;

a self-learning unit for acquiring feedback information, and updating the mapping rule according to the feedback information; the feedback information comprising indication information for indicating whether the evaluation result is correct.

As the mapping rule can be automatically updated, the work load of manually configuring the mapping rule is reduced greatly, and the accuracy of the mapping rule and the timeliness of the update is improved. By acquiring feedback information, the mapping rule can be updated in real time, so that an accurate evaluation result of the production process can be provided.

Optionally, in an embodiment, the production process evaluation model unit is further used for, after the evaluation result is generated and before the self-learning unit acquires the feedback information, sending evaluation result information for describing the evaluation result to an evaluation feedback device, the evaluation result information being used for the evaluation feedback device to display the evaluation result to an operator; and the self-learning unit is specifically used for receiving the feedback information from the evaluation feedback device, the feedback information being input on the evaluation feedback device by the operator according to the evaluation result.

By using the optional implementation method of at least one embodiment, the mapping rule can be modified according to the evaluation result input on the feedback device by the operator, so that a feedback opinion of the operator is collected in real time, and the mapping rule is timely updated.

Alternatively, optionally, the production process evaluation model unit of at least one embodiment is further used for, after the evaluation result is generated and before the self-learning unit acquires the feedback information, sending evaluation result information for describing the evaluation result to an evaluation feedback device; and the self-learning unit is specifically used for receiving the feedback information from the evaluation feedback device, the feedback information being obtained by the evaluation feedback device according to the evaluation result.

By using the optional implementation method of at least one embodiment, the mapping rule can be modified according to the feedback information generated by the feedback device per se.

Further alternatively, optionally, the mapping unit of at least one embodiment is further used for, after the production process evaluation model unit generates the evaluation result and before the self-learning unit acquires the feedback information, receiving second data generated subsequently in the production process, and determining a second execution condition of the production process according to the second data based on the mapping rule; the production process evaluation model unit is further used for determining the feedback information according to a time sequence relationship described in the production plan, the time sequence relationship being a relationship between the second execution condition and the first execution condition; and the self-learning unit is specifically used for acquiring the feedback information from the production process evaluation model unit.

By using the optional implementation method of at least one embodiment, the mapping rule is updated according to the subsequent execution condition of the production process, so that the purpose of accurately updating the mapping rule and obtaining a precise evaluation result is achieved.

Optionally, if the indication information indicates that the evaluation result is wrong, the feedback information further comprises: parameter modification information for modifying at least one parameter that describes the mapping rule.

By using the optional implementation method of at least one embodiment, a mapping rule parameter is modified, so that the modification for the mapping rule is more precise.

A third embodiment of the present invention provides a mapping rule updating device, comprising:

a memory for storing a mapping rule;

a receiver for receiving first data generated in a production process; and

a processor for:
determining a first execution condition of the production process according to the first data based on a mapping rule;
generating an evaluation result; the evaluation result being used for indicating whether the first execution condition is in line with a production plan of the production process;
acquiring feedback information, the feedback information comprising indication information for indicating whether the evaluation result is correct; and
updating the mapping rule according to the feedback information.

A fourth embodiment of the present invention provides a production process management system, comprising:

at least one data collection device for collecting first data generated in a production process, and sending the first data to a mapping rule updating device; and

the mapping rule updating device for:
receiving the first data;
determining a first execution condition of the production process according to the first data based on a mapping rule;
generating an evaluation result; the evaluation result being used for indicating whether the first execution condition is in line with a production plan of the production process;
acquiring feedback information, the feedback information comprising indication information for indicating whether the evaluation result is correct; and
updating the mapping rule according to the feedback information.

A fifth embodiment of the present invention provides a computer readable medium, wherein the computer readable medium stores computer instructions thereon, which when executed by a processor, cause the processor to perform the method provided in the first embodiment or any possible implementation method of the first embodiment.

In the third embodiment, fourth embodiment and fifth embodiment described above, as the mapping rule can be automatically updated, the work load of manually configuring the mapping rule is reduced greatly, improving the accuracy of the mapping rule and the timeliness of the update. By acquiring feedback information, the mapping rule can be updated in real time, so that an accurate evaluation result of the production process can be provided.

In order to guarantee the quality of products and improve production efficiency, a production manager needs to closely monitor a production process to find and solve an existing error and problem as soon as possible. After the digitizing technique is used, by comparing an event happening in the real physical world with an event happening in a production process plan, automatic monitoring for the production process can be achieved.

In the process of production process monitoring, data generated in a production process needs to be collected, the collected data in the real physical world is mapped into data or an event in a virtual world described by the production plan, and the production process is evaluated according to the mapped production data or event.

At present, some factories may use an enterprise resource planning (ERP) system and/or a manufacturing execution system (MES) to make a production plan, such as: performing production sequence scheduling, defining a production process, allocating resources such as tools, human resources, etc. The system such as the ERP system and MES may generate information for describing a production plan. The ERP system and MES here are examples only, and actually the information about a production plan may have a plurality of optional generation approaches, as long as the production plan can be described. Therefore, a correct mapping rule becomes very important, which decides the accuracy of an evaluation result for the production process.

In an actual production process, conditions such as a product change, a plant layout change, or a flow adjustment may always happen. These conditions may result in a frequent change in the mapping rule. For example: when a sensor is added or an old sensor is replaced, the mapping rule needs to be updated. How to timely update the mapping rule so as to accurately evaluate the production process becomes notably important.

At present, the mapping rule may generally be set in advance, and when the mapping rule needs to be changed, generally experienced technicians need to manually modify the mapping rule, which has the risk of inaccuracy and lack of timely changes.

The embodiments of the present invention provide a mapping rule updating method and device and a production process management system, for automatically updating a mapping rule, so as to timely and accurately update the mapping rule, and accurately evaluate a production process.

In the embodiments of the present invention, for the purpose of distinguishing, collected data generated in a production process is referred to as “field data (or field data on shop floor)”, and data described in a production plan is referred to as “production data”, and an event described in the production plan is referred to as a “production event”.

The embodiments of the present invention will be described in detail below with reference to the accompanying drawings.

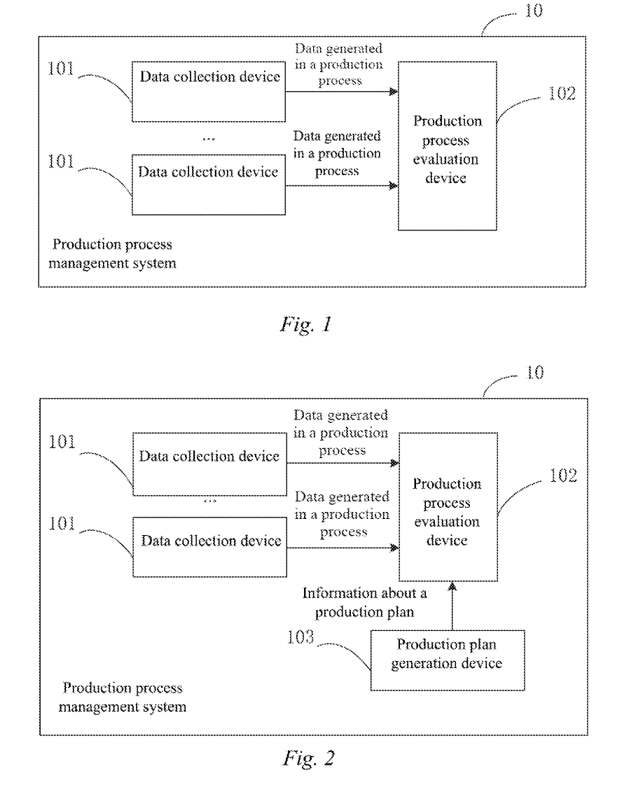

FIG. 1 is a schematic structural diagram of a production process management system 10 provided by an embodiment of the present invention. As shown in FIG. 1, the production management system 10 may comprise: at least one data collection device 101 and a production process evaluation device 102. The production process management system 10 manages a production process in a factory.

The data collection device 101 is used for collecting data generated in a production process, i.e. “field data”. The data collection device 101 can be any device that can generate the field data in the production process, such as: a sensor, a programmable logic controller (PLC), a radio frequency identification (RFID) reader/writer, a code scanner, etc. There are many types of sensors, such as: a pressure sensor, a speed sensor, a temperature sensor, a displacement sensor, etc. The PLC may store running state data, etc. of devices, and this data may also serve as the field data to be sent to the production process evaluation device 102.

The field data may comprise: position data of materials, personnel and tools, environmental data (such as: temperature, humidity, light, vibration data, etc.), device state data, etc.

The data collection device 101 sends the collected field data to the production process evaluation device 103, and the production process evaluation device 102 evaluates the production process based on this field data, for example: determining an execution condition of the production process according to the field data, thus determining whether the execution condition of the production process is in line with a production plan.

In the embodiment of the present invention, the production process evaluation device 102 determines the execution condition of the production process according to the field data based on a mapping rule. For example: determining that a certain event has occurred according to the field data, or determining that a certain event has not occurred at a pre-set moment according to the field data, etc.

Material transmission is taken as an example below for description. In the production process, an RFID reader/writer monitors whether a target material has reached a specified region. When a wireless signal emitted by an electronic label of the target material is read by the RFID reader/writer, field data may be sent to the production process evaluation device 102, the field data comprising identification information about the RFID reader/writer.

The mapping rule mentioned above may be a mapping rule from the field data to the production data.

For example: one possible mapping rule is (region A, RFID_1), then the production process evaluation device 102 maps field data containing the identification information of “RFID_1” into “region A” after receiving same, and then determines an execution condition of the production process according to “region A”. For example: according to the production plan, the target material needs to be delivered to region A, then the production process evaluation device 102 determines that the execution condition of the production process is in line with the production plan according to the mapped production data, i.e. determining an evaluation result of the production process.

For another example: taking wireless positioning as an example, the mapping rule is (region A: AP1 and AP2). This indicates that if signals from AP1 and AP2 are both detected, then a monitored object is located within region A.

The mapping rule mentioned above may also be a mapping rule from the field data to the production event.

For example: one possible mapping rule is (the target material has reached region A, RFID_1), then the production process evaluation device 102 maps field data containing the identification information of RFID_1 into the production event that “the target material has reached region A” after receiving same, then compares the mapped production event with the production plan, and determines that the execution condition of the production process is in line with the production plan, i.e. determining an evaluation result of the production process.

For another example: one possible mapping rule is (operation 001 has completed, RFID_1), it indicates that if read/write with an identifier of RFID_1 has monitored a monitored target, then operation 001 has been completed.

In an embodiment of the present invention, the production process evaluation device 102 is not only used for evaluating the production process, but also used for updating the mapping rule, wherein the production process evaluation device 102 may acquire feedback information, the feedback information comprising indication information for indicating whether the evaluation result is correct. The production process evaluation device 102 updates the mapping rule according to the feedback information, so as to ensure timely update of the mapping rule.

The mapping rule may be stored in the production process evaluation device 102 in advance, or stored in other devices in advance, and the production process evaluation device 102 may acquire the mapping rule from other devices during production process evaluation.

There may be a plurality of possible processing methods as follows when the production process evaluation device 102 is updating the mapping rule:

processing method I, the feedback information indicates that the evaluation result is correct, then the production process evaluation device 102 does not modify the mapping rule;

processing method II, once the feedback information indicates that the evaluation result is wrong, the production process evaluation device 102 modifies the mapping rule; and

processing method III, when and only when all the pieces of information of which the number exceeds a pre-set number indicate that the evaluation result is wrong, the production process evaluation device 102 modifies the mapping rule.

Using processing method III can avoid inappropriate modification of the mapping rule due to occasional wrong feedback information, and using processing method II can achieve timely modification of the mapping rule.

Using the embodiment of the present invention to update the mapping rule according to the feedback information achieves automatic and timely update of the mapping rule, ensures that the production process management system can evaluate the production process according to the timely updated mapping rule, and guarantees the accuracy of the evaluation result.

Optionally, the production process evaluation device 102 may store information for describing the production plan by itself, such as: information for describing the production plan stored in the form of a file or database. Alternatively, as shown in FIG. 2, the information about the production plan may also be acquired from a production plan generation device 103 which is used for generating the production plan. The production plan generation device 103 may comprise: one or more of an ERP device and an MES device. The production plan may comprise: an operation executed in the production process, a start time and end time of an operation, a resource used in an operation, which device is to execute an operation, etc.

Optionally, the production process evaluation device 102 acquires feedback information from an evaluation feedback device 104. The “explicit feedback method” described below may be referred to for details. Alternatively, the production process evaluation device 102 generates the feedback information per se, and the “implicit feedback method” described below may be referred to for details.

### I. Explicit Feedback Method

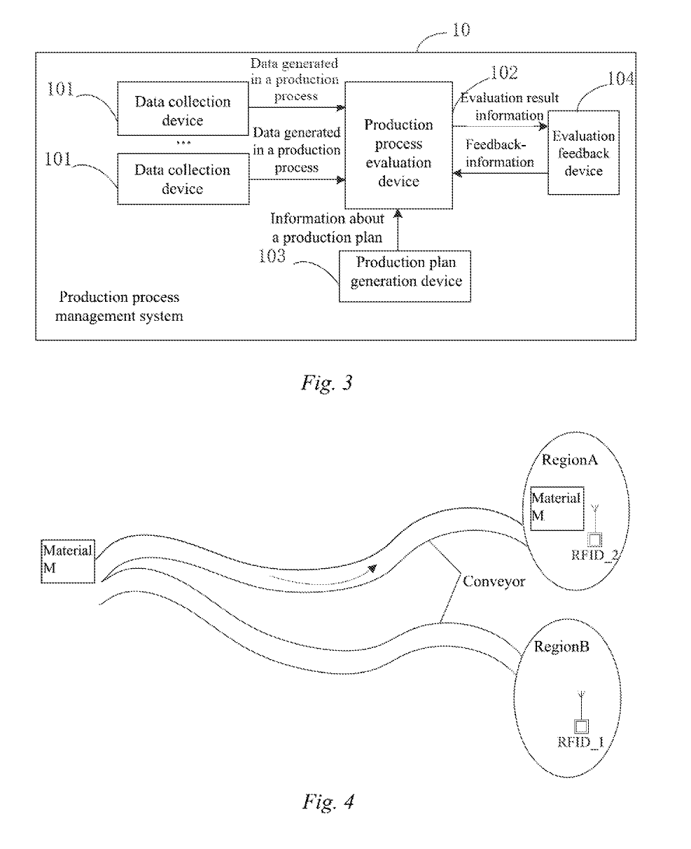

As shown in FIG. 3, the production process evaluation device 102 sends to the evaluation feedback device 104 evaluation result information for describing the evaluation result, and receives feedback information sent from the evaluation feedback device 104.

When generating the feedback information, the evaluation feedback device 104 may use a plurality of implementation methods including the following methods: [Method I]

After receiving the evaluation result information, the evaluation feedback device 104 determines an evaluation result according to the evaluation result information, and displays the evaluation result to an operator. After learning the evaluation result, the operator judges the evaluation result, and inputs feedback information for the evaluation result on the evaluation feedback device 104. The evaluation feedback device 104 then sends the feedback information input by the operator to the production process evaluation device 102.

With regard to method I, the evaluation feedback device 104 may be a console, and the feedback information may be input by the operator on the console. In addition, the evaluation feedback device 104 may also be a control device which monitors and maintains the production process, and may also be a third-party IT platform, and maintenance personnel input the feedback information on the evaluation feedback device 104, wherein the third-party IT platform may have an interface with the system as shown in FIG. 1 or FIG. 2, and data in the production process management system is accessed via the interface and is provided with feedback. This can be deemed as a part of the production process management system, and may also be deemed as not being contained in the production process management system.

Taking a factory as an example, consoles may be distributed at a plurality of places in the factory, and an operator (such as: a worker or a robot) may participate in the entire production process by operating on the console, such as: sending a control instruction, starting the next procedure, or feeding back the operating condition of the production process. The console may be a console in a centralized video monitoring system, and the operator learns the operating condition of the production process by way of video monitoring. The consoles may also be distributed at various places of production lines of the factory, and operators who are respectively responsible for the various production lines monitor the operating condition of the production process at those places.

Taking material transmission as an example, referring to FIG. 4, according to a production plan of the production process, material M should be sent to region A. In FIG. 4, in order to facilitate observing the moving of material M, a transmission method for a conveyor is shown. Actually other transmission methods are also applicable, such as: a method of manual lifting, a method applicable to forklift truck delivery or a transmission method using an automatic guided vehicle (AGV), etc.

In the scenario shown in FIG. 4, due to a factory plant layout change, the identification of the RFID reader/writer originally for monitoring the arrival of a target material in region A changes from the original RFID_1 into RFID_2, and the identification of the RFID reader/writer originally for monitoring the arrival of a target material in region B changes from the original RFID_2 into RFID_1.

However, the mapping rule for mapping field data of a data collection device 101 has not changed. For example: the original mapping rule is (region A, RFID_1) and (region B, RFID_2), indicating that RFID_1 corresponds to region A, for monitoring whether a target material has reached region A; and RFID_2 corresponds to region B, for monitoring whether a target material has reached region B.

In the example shown in FIG. 4, material M has successfully reached region A according to the production plan, and by sending a wireless signal, the RFID reader/writer RFID_2 in region A has sensed the arrival of material M after material M has entered region A and sent field data to the production process evaluation device 102, wherein the field data may comprise identification information about material M and identification information RFID_2 about the RFID reader/writer RFID_2.

After receiving the field data, the production process evaluation device 102 determines that material M has reached region B according to the original mapping rule. It needs to be noted that the judgement result is wrong. According to the production plan, the production process evaluation device 102 determines that material M should reach region A before a certain pre-determined moment, then upon the arrival of the pre-determined moment, it can be determined that material M has not reached region A, then evaluation result information is generated, and the evaluation result information is used for indicating that material M has not reached region A.

After receiving the evaluation result information, the evaluation feedback device 104, which is a console herein, displays an evaluation result to an operator, such as: Displaying on the screen of the console or a voice prompt: material M has not reached region A. However, by monitoring the production process, the operator has determined that material M has reached region A, then feedback information may be input via a button on the console or a key on a computer keyboard, etc.

After receiving the feedback information, the production process evaluation device 102 may update the mapping rule according to the feedback information. Since the original mapping rule is (region A, RFID_1), according to previously collected field data, the production process evaluation device 102 determines that material M has reached the region where the RFID reader/writer RFID_2 is located, then in combination with the feedback information, the production process evaluation device 102 may determine that the new mapping rule may be (region A, RFID_2).

Optionally, the production process evaluation device 102 may receive the same type of feedback information for a plurality of times, that is, the mapping rule is updated after the target material which should reach region A has reached region A, so as to avoid occasional erroneous judgement; and certainly the mapping rule may also be updated when the feedback information is received the first time.

There are a plurality of optional methods for implementing the feedback information, for example: only indicating whether the evaluation result is correct. For another example: not indicating that the evaluation result is wrong, but also indicating what should be a correct evaluation result.

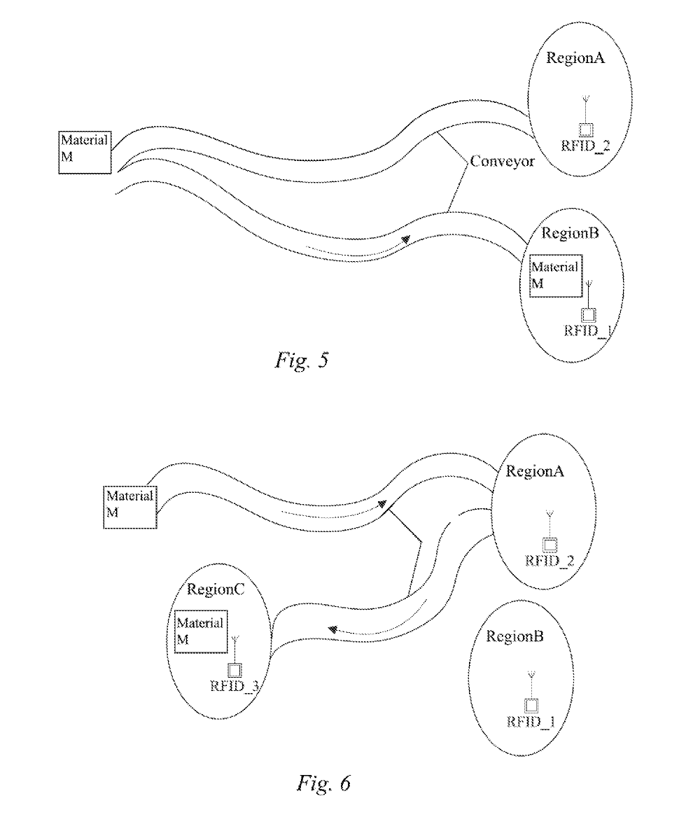

Still taking the above material transmission as an example, in order to more clearly describe the contents of the feedback information, the scenario shown in FIG. 5 is taken as an example. Being the same as the scenario shown in FIG. 4, material M should be transmitted to region A according to the production plan of the production process, likewise, the identification of the RFID reader/writer originally for monitoring the arrival of a target material in region A changes from the original RFID_1 into RFID_2, and the identification of the RFID reader/writer originally for monitoring the arrival of a target material in region B changes from the original RFID_2 into RFID_1.

Being different from the scenario shown in FIG. 4, material M has been erroneously transmitted to region B. However, according to the original mapping rule, the production process evaluation device 102 determines that material M has successfully reached region A according to the production plan. Then, the production process evaluation device 102 sends evaluation result information to the evaluation feedback device 104, i.e. a console, indicating that material M has successfully reached region A. The console displays the evaluation result to the operator. The operator has not monitored that material M has reached region A before a pre-set moment when material M reaches region A at the latest, then inputs feedback information on the console. The feedback information does not only indicate that the evaluation result is wrong, but also indicates that material M has reached region B. After receiving the feedback information, the production process evaluation device 102 may change the original mapping rule (region B, RFID_2) into (region B, RFID_1) according to the feedback information.

### [Method II]

After receiving the evaluation result information, the evaluation feedback device 104 determines feedback information according to the evaluation result information, and sends the feedback information to the production process evaluation device 102.

Method II differs from Method I in that the feedback information is generated by the evaluation feedback device 104 per se, without needing to be input by an operator. For example: in a vehicle assembly shop, in working procedure 1, a wheel needs to be mounted on a vehicle; and in working procedure 2, the rotational speed of the wheel is detected via a wheel speed detection device. When working procedure 1 has finished, an RFID reader/writer has monitored the wheel, and sends the RFID thereof to the production process evaluation device 102, and the production process evaluation device 102 determines that the wheel has been successfully mounted on the vehicle on this basis; and sends feedback information to the wheel speed detection device in working procedure 2 which serves as the evaluation feedback device 104, indicating that the execution condition of the production process is in line with an evaluation result of a production plan. However, if the wheel is not detected when the wheel speed detection device detects the rotational speed of a wheel, then feedback information is sent to the production process evaluation device 102, indicating that the evaluation result is wrong. The production process evaluation device 102 may update the mapping rule according to the feedback information.

### II. Implicit Feedback Method

When the implicit feedback method is used, the production process evaluation device 102 generates feedback information thereby, without needing to acquire the feedback information from the evaluation feedback device 104. At this time, the production process management system may be as shown in FIG. 1 or FIG. 2.

When the implicit feedback method is used, the production process evaluation device 102 may receive field data generated in a production process subsequently, and determine a further execution condition of the production process according to the subsequent field data based on a mapping rule. When the feedback information is generated, the production process evaluation device 102 may determine the feedback information according to a time sequence relationship described in the production plan, wherein the time sequence relationship is a relationship between the determined further execution condition of the production process and a previously determined execution condition of the production process.

With reference to FIG. 6, according to the production plan, material M needs to be first transmitted to region A for packaging, then transmitted to region C, and the mapping rule before update includes: (region A, RFID_1), (region B, RFID_2), (region C, RFID_3). Similar to the scenario shown in FIG. 4, the identification of the RFID reader/writer originally for monitoring the arrival of a target material in region A changes from the original RFID_1 into RFID_2, and the identification of the RFID reader/writer originally for monitoring the arrival of a target material in region B changes from the original RFID_2 into RFID_1.

When material M reaches region A, the RFID reader/writer RFID_2 reports the identification RFID_2 thereof to the production process evaluation device 102, and the production process evaluation device 102 obtains an evaluation result that material M has reached region B according to the mapping rule (region B, RFID_2). Before a pre-set moment when material M reaches region A at the latest, the production process evaluation device 102 does not receive the identification RFID_1 sent from the RFID reader/writer RFID_1, then an evaluation result that material M has not reached region A is obtained.

When material M reaches region C, the RFID reader/writer RFID_3 reports the identification RFID_3 thereof to the production process evaluation device 102, and the production process evaluation device 102 obtains an evaluation result that material M has reached region C according to the received RFID_3 and the mapping rule (region C, RFID_3).

The production process evaluation device 102 determines a time sequence relationship that material M needs to reach region A first for packaging and then reaches region C according to the production plan, and learns that there are no conveyor connections between region B and region A and between region B and region C according to recorded plant layout information. Then it is determined that material M has passed region A and the production process is in line with the production plan (since it is impossible that material M reaches region B, but it can only reach region C after passing region A and after being packaged), and therefore the mapping rule (region A, RFID_1) can be updated to (region A, RFID_2).

Optionally, in addition to indication information for indicating whether the evaluation result is correct, if the indication information indicates that the evaluation result is wrong, then the feedback information may also comprise: parameter modification information for modifying at least one parameter that describes the mapping rule,

wherein the parameter modification information may directly indicate a new parameter value, or indicate a modification method for the parameter value, for example: with regard to a power judgement threshold, increasing one step length value or decreasing one step length value may be indicated, wherein the step length value may be a default value; or the parameter modification information further comprises information indicating the value of the step length.

With reference to FIG. 7, region A and region B exist in the plant, wherein an RFID reader/writer RFID_1 is deployed in region A, and an RFID reader/writer RFID_2 is deployed in region B, wherein since a received power threshold value of the RFID reader/writer RFID_1 recorded in the mapping rule is set too low, the power transmitted by an electronic label of a target material received by the RFID reader/writer RFID_1 when the target material reaches the shadow region shown in FIG. 7 exceeds the received power threshold mentioned above, so that the RFID reader/writer RFID_1 may report the identification RFID_1 thereof to a production process evaluation device 102. A production plan generation device 103 determines that the target material has reached region A rather than B on this basis, wherein the received power value may be a received signal strength indication (RSSI).

In FIG. 7, the solid line is used for indicating the actual region size. The dashed line is the size of a region where the target material monitored by the RFID reader/writer according to the received power threshold value of the RFID reader/writer RFID_1 recorded in the mapping rule is located.

When comparing the obtained execution condition of the production process that the target material has reached region A with a production plan, the production plan generation device 103 obtains an evaluation result that the execution condition of the production process is not in line with the production plan.

Evaluation result information for indicating the evaluation result is sent to an evaluation feedback device 104, such as a console, and an operator determines that a target device or material has reached region B, then sends feedback information to the production process evaluation device 102, the feedback information comprising indication information for indicating that the evaluation result is incorrect. Furthermore, the operator may also indicate increasing the received power threshold value of the RFID reader/writer RFID_1 in the mapping rule by one or a plurality of step lengths by inputting parameter modification information via the console, so as to avoid erroneously judging that the target material actually having reached region B has reached region A.

Alternatively, the feedback information only comprises indication information indicating that the evaluation result is incorrect. The production process evaluation device 102 determines that the target material has reached region B previously but was erroneously judged as having reached region A according to a position relationship between region A and region B known in advance and according to a subsequent execution condition of the production process (e.g. the target material has been used). Therefore, it can be determined that the received power threshold value of the RFID reader/writer RFID_1 in the mapping rule is set too low, and thus parameter modification information for increasing the received power threshold value of the reader/writer RFID_1 can be determined, and the received power threshold value of the reader/writer RFID_1 can be further determined through modification according to the parameter modification information.

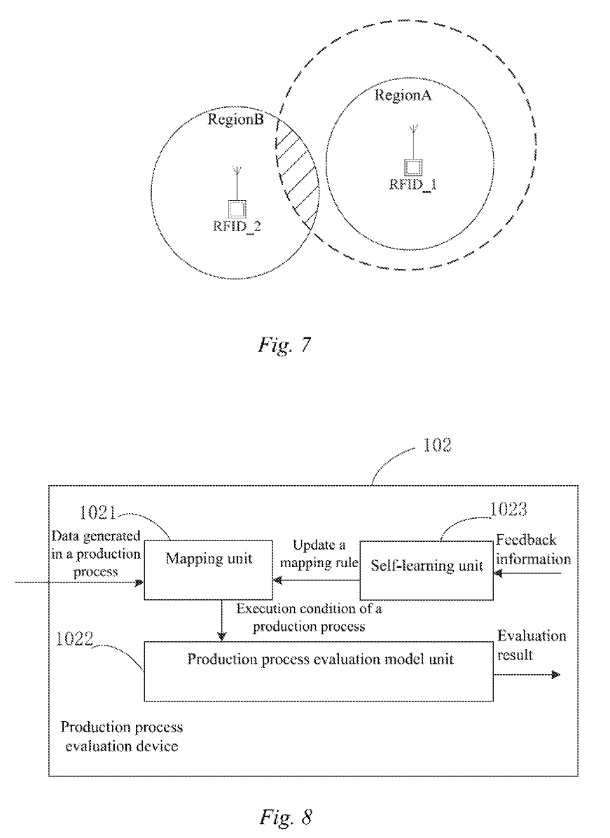

The constitution of the production process management system 10, interactions between devices and updating solution for the mapping rule provided by the embodiments of the present invention are introduced above. The constitution and implementation method of the production process evaluation device 102 in the production process management system 10 will be introduced below with reference to FIG. 8. Since the production process evaluation device 102 in the embodiment of the present invention achieves updating a mapping rule, the production process evaluation device 102 may also be referred to as a mapping rule updating device.

As shown in FIG. 8, the production process evaluation device 102 may comprise:

a mapping unit 1021 for receiving first data generated in a production process; and determining a first execution condition of the production process according to the first data based on a mapping rule;

a production process evaluation model unit 1022, for generating an evaluation result; the evaluation result being used for indicating whether the first execution condition is in line with a production plan of the production process;

a self-learning unit 1023, for acquiring feedback information, and updating the mapping rule according to the feedback information; the feedback information comprising indication information indicating whether the evaluation result is correct,

wherein information about the production plan can be stored in the production process evaluation device 102 in advance, for example: the information is stored in the production process evaluation model unit, or, as described previously, it can also be acquired from the production plan generation device 103 by way of the production process evaluation model unit 1022.

The feedback information may be generated by the evaluation feedback device 104 and sent to the self-learning unit 1023, or generated by the production process evaluation model unit 1022 and sent to the self-learning unit 1023. With regard to the former condition, the production process evaluation model unit 1022 generates evaluation result information for describing an evaluation result and sends same to an evaluation feedback device 104,

wherein, optionally, the production process evaluation model unit 1022 is further used for, after the evaluation result is generated and before the self-learning unit 1023 acquires the feedback information, sending to the evaluation feedback device 104 evaluation result information for describing the evaluation result, the evaluation result information being used for displaying the evaluation result to an operator by the evaluation feedback device 104; and the self-learning unit 1023 is specifically used for receiving the feedback information from the evaluation feedback device 104, the feedback information being input on the evaluation feedback device 104 by the operator according to the evaluation result.

Alternatively, the production process evaluation model unit 1022 is further used for, after the evaluation result is generated and before the self-learning unit 1023 acquires the feedback information, sending to the evaluation feedback device 104 evaluation result information for describing the evaluation result; and the self-learning unit 1023 is specifically used for receiving the feedback information from the evaluation feedback device 104, the feedback information being obtained by the evaluation feedback device 104 according to the evaluation result.

Further alternatively, the mapping unit 1021 is further used for, after the production process evaluation model unit 1022 generates the evaluation result and before the self-learning unit 1023 acquires the feedback information, receiving second data generated subsequently in the production process, and determining a second execution condition of the production process according to the second data based on the mapping rule; the production process evaluation model unit 1022 is further used for determining the feedback information according to a time sequence relationship described in the production plan, the time sequence relationship being a relationship between the second execution condition and the first execution condition; and the self-learning unit 1023 is specifically used for acquiring the feedback information from the production process evaluation model unit 1022.

Optionally, if the indication information indicates that the evaluation result is wrong, then the feedback information further comprises: parameter modification information for modifying at least one parameter that describes the mapping rule,

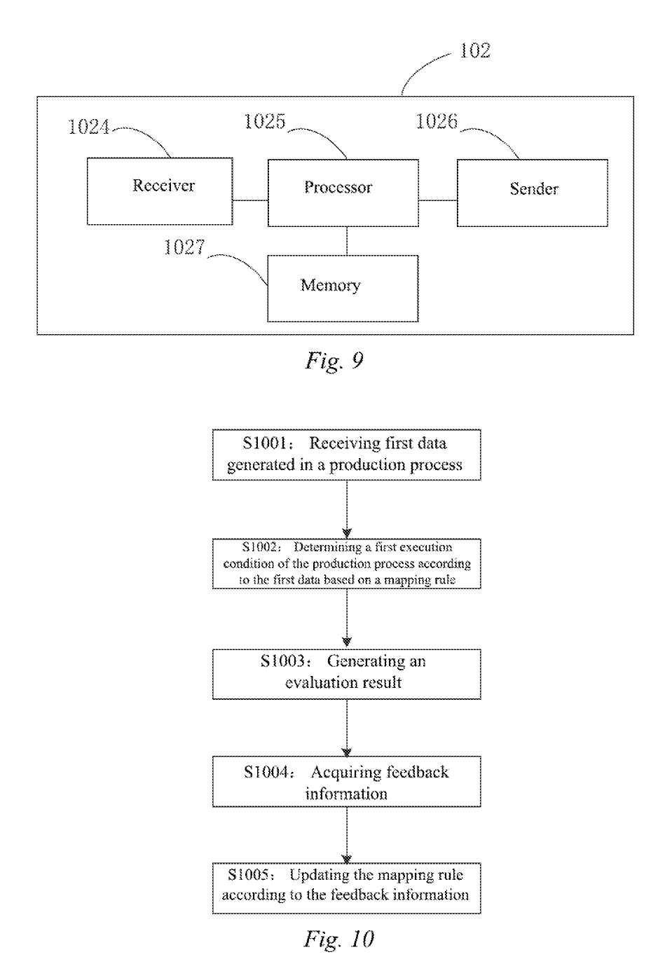

As shown in FIG. 9, the production process evaluation device 102 may comprise a receiver 1024, a processor 1025 and a memory 1027 in specific implementation,

wherein the memory 1027 is used for storing a mapping rule; and

the receiver 1024 is used for accomplishing a receiving operation of the production process evaluation device 102. For example: field data generated in the production process is received from the data collection device 101; optionally, information for describing the production plan may also be received from the production plan generation device 103; and optionally, feedback information may also be received from the evaluation feedback device 104, etc.,

wherein the receiver 1024 may receive data and information in a wireless manner, such as: receiving the field data using a technique of wireless fidelity (WiFi), etc., or data and information may also be received in a wired manner, such as: receiving feedback information using a technique of optical transmission, etc.

The processor 1025 is used for accomplishing a processing operation of the production process evaluation device 102, such as: determining an execution condition of the production process according to field data generated in a production process, evaluating the execution condition of the production process, updating the mapping rule, etc.

Optionally, the processor 1025 is further used for generating evaluation result information for describing the evaluation result. The production process evaluation device 102 further comprises a sender 1026, for sending to the evaluation feedback device 104 evaluation result information, the evaluation result information being used for displaying the evaluation result to an operator by the evaluation feedback device 104; the receiver 1024 is further used for receiving the feedback information from the evaluation feedback device 104, the feedback information being input on the evaluation feedback device 104 by the operator according to the evaluation result; and the processor 1025 is specifically used for acquiring the feedback information from the receiver 1024.

Alternatively, the processor 1025 is further used for generating evaluation result information for describing the evaluation result; the sender 1026 is used for sending the evaluation result information to the evaluation feedback device 104; the receiver 1024 is further used for receiving the feedback information from the evaluation feedback device 104, the feedback information being obtained and sent by the evaluation feedback device 104 according to the evaluation result; and the processor 1025 is specifically used for acquiring the feedback information from the receiver 1024.

Further alternatively, the receiver 1024 is further used for receiving second data generated subsequently in the production process after the evaluation result is generated and before the feedback information is acquired by the processor 1025; the processor 1025 is further used for determining a second execution condition of the production process according to the second data based on the mapping rule; and the processor 1025 is specifically used for determining the feedback information according to a time sequence relationship described in the production plan, the time sequence relationship being a relationship between the second execution condition and the first execution condition.

Optionally, if the indication information indicates that the evaluation result is wrong, then the feedback information further comprises: parameter modification information for modifying at least one parameter that describes the mapping rule,

An embodiment of the present invention further provides a mapping rule updating method. The method can be executed by the aforementioned production process evaluation device 102. As shown in FIG. 10, the method may comprise the following steps:

S1001: receiving first data generated in a production process;

S1002: determining a first execution condition of the production process according to the first data based on a mapping rule;

S1003: generating an evaluation result; the evaluation result being used for indicating whether the first execution condition is in line with a production plan of the production process;

S1004: acquiring feedback information, the feedback information comprising indication information for indicating whether the evaluation result is correct; and

S1005: updating the mapping rule according to the feedback information.

Optionally, after step S1003 of generating an evaluation result and before step S1004 of acquiring feedback information, the method further comprises: sending evaluation result information for describing the evaluation result to an evaluation feedback device, the evaluation result information being used for displaying the evaluation result to an operator by the evaluation feedback device, wherein step S1004 of acquiring feedback information comprises: receiving the feedback information from the evaluation feedback device, the feedback information being input on the evaluation feedback device by the operator according to the evaluation result.

Alternatively, after step S1003 of generating an evaluation result and before step S1004 of acquiring feedback information, the method further comprises: sending evaluation result information for describing the evaluation result to an evaluation feedback device, wherein step S1004 of acquiring feedback information comprises: receiving the feedback information from the evaluation feedback device, the feedback information being obtained by the evaluation feedback device according to the evaluation result.

Further alternatively, after step S1003 of generating an evaluation result and before step S1004 of acquiring feedback information, the method further comprises: receiving second data generated subsequently in the production process; and determining a first execution condition of the production process according to the first data based on a mapping rule; step S1004 of acquiring feedback information comprises: determining the feedback information according to a time sequence relationship described in the production plan, the time sequence relationship being a relationship between the second execution condition and the first execution condition.

Optionally, if the indication information indicates that the evaluation result is wrong, then the feedback information further comprises: parameter modification information for modifying at least one parameter that describes the mapping rule.

Other optional implementation methods of the method may refer to the aforementioned processing of the production process evaluation device 102, and will not be described again herein.

An embodiment of the present invention further provides a computer storage medium, storing an instruction for causing a machine to execute the checking method of program codes as described herein. Specifically, a system or apparatus with a storage medium may be provided, and software program codes for implementing the functions of any one of the embodiments described above are stored on the storage medium, and a computer (or CPU or MPU) of the system or apparatus is caused to read and execute the program codes stored in the storage medium.

In this condition, the program codes per se read from the storage medium may implement the functions of any one of the embodiments described above, and therefore the program codes and the storage medium storing the program codes constitute a part of an embodiment of the present invention.

The embodiments of the storage medium for providing the program codes comprise a floppy disk, a hard disk, a magnetic optical disc, an optical disc (such as CD-ROM, CD-R, CD-RW, DVD-ROM, DVD-RAM, DVD-RW and DVD+RW), a magnetic tape, a non-volatile memory card and ROM. Optionally, the program codes may be downloaded from a server computer via a communication network.

In addition, it should be clear that the operating system operating on a computer may be caused to accomplish some or all of the actual operations not only by executing the program codes read out by the computer, but also based on an instruction of the program codes, thereby implementing the functions of any one of the embodiments described above.

In addition, it can be understood that the program codes read out from the storage medium are written into a memory provided in an expansion board inserted into the computer or written into a memory provided in an expansion unit connected to the computer, then a CPU installed on the expansion board or the expansion unit is caused to execute some or all of the actual operations based on an instruction of the program codes, thereby implementing the functions of any one of the embodiments described above.

In summary, by using the embodiments of the present invention, as the mapping rule can be automatically updated, the work load of manually configuring the mapping rule is reduced greatly, improving the accuracy of the mapping rule and the timeliness of the update. By acquiring feedback information, the mapping rule can be updated in real time, so that an accurate evaluation result of the production process can be provided.

It needs to be noted that not all the steps and modules in the flows and structural diagrams of the system described above are necessary, and some steps or modules may be omitted according to practical requirements. The execution order of the various steps is not fixed and may be adjusted according to requirements. The system structure described in the various embodiments above may be a physical structure and may also be a logical structure, i.e. some modules may be implemented by the same physical entity, or some modules may be implemented separately by a plurality of physical entities, or may be implemented together by some components in a plurality of independent devices.

In the various embodiments above, a hardware unit may be implemented mechanically or electrically. For example, a hardware unit may comprise a permanent dedicated circuit or logic (such as a dedicated processor, FPGA or ASIC) to accomplish a corresponding operation. The hardware unit may also comprise a programmable logic or circuit (such as a general-purpose processor or other programmable processors), and may be set temporarily by hardware to accomplish a corresponding operation. The specific implementation method (mechanically, or a dedicated permanent circuit, or a temporarily set circuit) may be determined in consideration of cost and time.

The present invention is illustrated and described in detail above by way of drawings and preferred embodiments; however, the present invention is not limited to these disclosed embodiments. Based on the plurality of embodiments described above, those skilled in the art would know that code checking device in different embodiments above may be combined to obtain more embodiments of the present invention, and these embodiments also fall within the scope of protection of the present invention.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mapping rule updating method, the method comprising:
receiving first data generated in a production process;
determining a first execution condition of the production process according to the first data based on a mapping rule;
generating an evaluation result, the evaluation result indicating whether the first execution condition is in line with a production plan of the production process;
acquiring feedback information, the feedback information including indication information indicating whether the evaluation result is correct; and
updating the mapping rule according to the feedback information.

2. The method of claim 1, wherein:
after generating the evaluation result and before acquiring the feedback information, the method further comprises:
sending evaluation result information for describing the evaluation result to an evaluation feedback device, the evaluation result information being usable for the evaluation feedback device to display the evaluation result to an operator; and
wherein the acquiring of feedback information comprises: receiving the feedback information from the evaluation feedback device, the feedback information being inputtable on the evaluation feedback device by the operator according to the evaluation result.

3. The method of claim 1, wherein:
after generating the evaluation result and before acquiring the feedback information, the method further comprises:
sending evaluation result information for describing the evaluation result to an evaluation feedback device; and
wherein the acquiring of the feedback information comprises:
receiving the feedback information from the evaluation feedback device, the feedback information being obtainable by the evaluation feedback device according to the evaluation result.

4. The method of claim 1, wherein:
after generating the evaluation result and before acquiring the feedback information, the method further comprises:
receiving second data generated subsequently in the production process; and
determining a second execution condition of the production process according to the second data based on the mapping rule; and
wherein the acquiring of the feedback information comprises:
determining the feedback information according to a time sequence relationship described in the production plan, the time sequence relationship being a relationship between the second execution condition and the first execution condition.

5. The method of claim 1, wherein, upon the indication information indicating that the evaluation result is wrong, the feedback information further comprises:
parameter modification information for modifying at least one parameter that describes the mapping rule.

6. A mapping rule updating device, comprising:
a mapping unit to receive first data generated in a production process and to determine a first execution condition of the production process according to the first data based on a mapping rule;
a production process evaluation model unit to generate an evaluation result, the evaluation result indicating whether the first execution condition is in line with a production plan of the production process; and
a self-learning unit to acquire feedback information, and to update the mapping rule according to the feedback information, the feedback information including indication information to indicate whether the evaluation result is correct.

7. The device of claim 6, wherein:
the production process evaluation model unit is further usable to, after the evaluation result is generated and before the self-learning unit acquires the feedback information, send evaluation result information for describing the evaluation result to an evaluation feedback device, the evaluation result information being usable for the evaluation feedback device to display the evaluation result to an operator; and
wherein the self-learning unit is usable to receive the feedback information from the evaluation feedback device, the feedback information being input on the evaluation feedback device by the operator according to the evaluation result.

8. The device of claim 6, wherein:
the production process evaluation model unit is further usable to, after the evaluation result is generated and before the self-learning unit acquires the feedback information, send evaluation result information for describing the evaluation result to an evaluation feedback device; and
wherein the self-learning unit is usable to receive the feedback information from the evaluation feedback device, the feedback information being obtained by the evaluation feedback device according to the evaluation result.

9. The device of claim 6, wherein:
the mapping unit is further usable to, after the production process evaluation model unit generates the evaluation result and before the self-learning unit acquires the feedback information, receive second data generated subsequently in the production process, and to determine a second execution condition of the production process according to the second data based on the mapping rule;
wherein the production process evaluation model unit is further usable to determine the feedback information according to a time sequence relationship described in the production plan, the time sequence relationship being a relationship between the second execution condition and the first execution condition; and
wherein the self-learning unit is usable to acquire the feedback information from the production process evaluation model unit.

10. The device of claim 6, wherein, upon the indication information indicating that the evaluation result is wrong, the feedback information further includes:
parameter modification information to modify at least one parameter describing the mapping rule.

11. A mapping rule updating device, comprising:
a memory storing a mapping rule;
a receiver to receive first data generated in a production process; and
a processor configured to:
determine a first execution condition of the production process according to the first data based on the mapping rule;
generate an evaluation result, usable to indicate whether the first execution condition is in line with a production plan of the production process;
acquire feedback information, the feedback information including indication information to indicate whether the evaluation result is correct; and
update the mapping rule according to the feedback information.

12. The device of claim 11, wherein:
the processor is further configured to generate evaluation result information for describing the evaluation result, the device further comprising:
a sender to send the evaluation result information to an evaluation feedback device, the evaluation result information being usable by the evaluation feedback device to display the evaluation result to an operator;
wherein the receiver is further used to receive the feedback information from the evaluation feedback device, the feedback information being inputtable on the evaluation feedback device by the operator according to the evaluation result; and
wherein the processor is further configured to acquire the feedback information from the receiver.

13. The device of claim 11, wherein:
the processor is further configured to generate evaluation result information for describing the evaluation result;
the device further comprising:
a sender to send the evaluation result information to an evaluation feedback device;
wherein the receiver is further usable to receive the feedback information from the evaluation feedback device, the feedback information being obtained and sent by the evaluation feedback device according to the evaluation result; and
wherein the processor is further configured to acquire the feedback information from the receiver.

14. The device of claim 11, wherein:
the receiver is further configured to receive, after the processor generates the evaluation result and before the feedback information is acquired, second data generated subsequently in the production process;
wherein the processor is further configured to determine a second execution condition of the production process according to the second data based on the mapping rule; and
wherein the processor is further configured to determine the feedback information according to a time sequence relationship described in the production plan, the time sequence relationship being a relationship between the second execution condition and the first execution condition.

15. The device of claim 11, wherein, upon the indication information indicating that the evaluation result is wrong, the feedback information further includes:
parameter modification information usable to modify at least one parameter that describes the mapping rule.

16. A production process management system, comprising:
at least one data collection device to collect first data generated in a production process, and to send the first data to a mapping rule updating device; and
the mapping rule updating device being configured to:
receive the first data;
determine a first execution condition of the production process according to the first data based on a mapping rule;
generate an evaluation result, the evaluation result being usable to indicate whether the first execution condition is in line with a production plan of the production process;
acquire feedback information, the feedback information including indication information indicating whether the evaluation result is correct; and
update the mapping rule according to the feedback information.

17. The system of claim 16, further comprising:
an evaluation feedback device;
wherein the mapping rule updating device is further configured to send evaluation result information for describing the evaluation result to the evaluation feedback device;
wherein the evaluation feedback device is further configured to
receive the evaluation result information,
determine the evaluation result according to the evaluation result information,
display the evaluation result to an operator,
receive the feedback information input by the operator according to the evaluation result, and
send the feedback information to the mapping rule updating device;
wherein the mapping rule updating device is further configured to receive the feedback information from the evaluation result information.

18. A non-transitory computer readable medium, storing computer instructions thereon, the computer instructions, when executed by a processor, being configured to cause the processor to perform the method of claim 1.

19. A mapping rule updating device, comprising:
a memory storing program computer-readable instructions; and
one or more processors configured to execute the instructions such that the one or more processors are configured to,
receive first data generated in a production process and determine a first execution condition of the production process according to the first data based on a mapping rule;
generate an evaluation result; the evaluation result being used for indicating whether the first execution condition is in line with a production plan of the production process; and
acquire feedback information, and update the mapping rule according to the feedback information; the feedback information comprising indication information for indicating whether the evaluation result is correct.

20. The method of claim 2, wherein, upon the indication information indicating that the evaluation result is wrong, the feedback information further comprises:
parameter modification information for modifying at least one parameter describing the mapping rule.

21. The method of claim 3, wherein, upon the indication information indicating that the evaluation result is wrong, the feedback information further comprises:
parameter modification information for modifying at least one parameter describing the mapping rule.

22. The method of claim 4, wherein, upon the indication information indicating that the evaluation result is wrong, the feedback information further comprises:
parameter modification information for modifying at least one parameter describing the mapping rule.

23. The device of claim 7, wherein, upon the indication information indicating that the evaluation result is wrong, the feedback information further includes:
parameter modification information to modify at least one parameter describing the mapping rule.

24. The device of claim 8, wherein, upon the indication information indicating that the evaluation result is wrong, the feedback information further includes:
parameter modification information to modify at least one parameter describing the mapping rule.

25. The device of claim 9, wherein, upon the indication information indicating that the evaluation result is wrong, the feedback information further includes:
parameter modification information to modify at least one parameter describing the mapping rule.

26. The device of claim 12, wherein, upon the indication information indicating that the evaluation result is wrong, the feedback information further includes:
parameter modification information usable to modify at least one parameter that describes the mapping rule.

27. The device of claim 13, wherein, upon the indication information indicating that the evaluation result is wrong, the feedback information further includes:
parameter modification information usable to modify at least one parameter that describes the mapping rule.

28. The device of claim 14, wherein, upon the indication information indicating that the evaluation result is wrong, the feedback information further includes:
parameter modification information usable to modify at least one parameter that describes the mapping rule.

29. The system of claim 16, further comprising:
an evaluation feedback device;
wherein the mapping rule updating device is further configured to send evaluation result information for describing the evaluation result to the evaluation feedback device;
wherein the evaluation feedback device is further configured to
receive the evaluation result information,
determine the feedback information according to the evaluation result information, and
send the feedback information to the mapping rule updating device; and
wherein the mapping rule updating device is further configured to receive the feedback information from the evaluation result information.

30. A non-transitory computer readable medium, storing computer instructions thereon, the computer instructions, when executed by a processor, being configured to cause the processor to perform the method of claim 2.

31. A non-transitory computer readable medium, storing computer instructions thereon, the computer instructions, when executed by a processor, being configured to cause the processor to perform the method of claim 3.

32. A non-transitory computer readable medium, storing computer instructions thereon, the computer instructions, when executed by a processor, being configured to cause the processor to perform the method of claim 4.
